(19) United States
(12) Patent Application Publication
(10) Pub. No.: US 2026/0153145 A1
(43) Pub. Date: Jun. 4, 2026

(54) DISPLAY MODULE FOR A MOBILITY DEVICE AND A GEAR SHIFTING METHOD USING THE SAME

(71) Applicant: HYUNDAI AUTOEVER CORP., Seoul (KR)

(72) Inventors: Won Heung Jo, Seoul (KR); Jung Eun Kim, Seoul (KR); Jin Young Han, Seoul (KR); Moon Jeong Kim, Seoul (KR); Gang Seok Suh, Seoul (KR)

(73) Assignee: HYUNDAI AUTOEVER CORP., Seoul (KR)

(21) Appl. No.: 19/350,721

(22) Filed: Oct. 6, 2025

(30) Foreign Application Priority Data
Nov. 29, 2024 (KR) 10-2024-0174657

(51) Int. Cl. F16H 59/10; B60K 35/10

(52) U.S. Cl. CPC F16H 59/105; B60K 35/10; B60K 2360/119; B60K 2360/1438

(57) ABSTRACT

A display module for a mobility device includes a display configured to display a gear area including a plurality of gear buttons in a first region, the first region being part of an entire display screen. The display module also includes a controller configured to output an angle change signal for changing to an angle corresponding to a changed gear, based on determining occurrence of a gear change in response to a user operation on the gear area. The display module further includes an angle adjuster configured to receive the angle change signal from the controller and adjust a screen angle of the display.

### CROSS-REFERENCE TO RELATED APPLICATION

This application claims the benefit of and priority to Korean Patent Application No. 10-2024-0174657, filed on Nov. 29, 2024, the entire contents of which are hereby incorporated herein by reference.

### TECHNICAL FIELD

The present disclosure relates to a display module for a mobility device and a gear shifting method using the same.

### BACKGROUND

As software-defined vehicle (SDV) technology advances, it has become possible to shift gears via touch input on a screen instead of traditional hardware-based gear shifting. An SDV is a vehicle in which hardware is managed by software, transforming the vehicle from a simple mechanical device into a dynamic software platform and thereby offering new functions and user experiences.

Conventional gear shifting methods based on SDV technology typically involve shifting the gear of a vehicle by scrolling a vehicle icon on a display. Therefore, it is difficult for the driver to intuitively understand the current gear state, which may interfere with the driver's concentration.

In addition, according to the conventional gear shifting methods based on software-defined vehicle technology, if an error occurs in the display, it may become difficult to shift gears.

### SUMMARY

Aspects of the present disclosure provide a device and method that allow the driver to intuitively check the current gear state of the vehicle and still shift gears even if an error occurs in the display that provides the gear shifting function.

Aspects of the present disclosure provide a display module for a mobility device and a gear shifting method using the same, in which the screen angle of a computing device is adjusted (e.g., automatically adjusted) in response to a user operation on a gear area, thereby allowing a user to intuitively recognize the changed gear state of a vehicle.

Aspects of the present disclosure provide a display module and a gear shifting method using the same, that allow a user to change the gear of a vehicle by adjusting the angle of a display even when an abnormality is detected in the display.

The objectives of the present disclosure are not limited to those mentioned above. Other objectives not explicitly stated herein should be more clearly understood by those having ordinary skill in the art from the following description.

According to an aspect of the present disclosure, a display module for a mobility device is provided. The display module comprises a display configured to display a gear area including a plurality of gear buttons in a first region, is the first region being part of an entire display screen. The mobility module also comprises a controller configured to output an angle change signal for changing to an angle corresponding to a changed gear, based on determining occurrence of a gear change in response to a user operation on the gear area. The display module additionally comprises an angle adjuster configured to receive the angle change signal from the controller and adjust a screen angle of the display.

In some embodiments, the display is configured to display a gear button, among the plurality of gear buttons, corresponding to the changed gear in a visually different manner from other gear buttons among the plurality of gear buttons.

In some embodiments, the angle adjuster is configured to tilt the display up and down with respect to a horizontal axis.

In some embodiments, the gear area includes the plurality of gear buttons arranged vertically.

In some embodiments, the angle adjuster is configured to swivel the display left and right with respect to a vertical axis.

In some embodiments, the gear area includes the plurality of gear buttons arranged horizontally.

In some embodiments, the angle adjuster is configured to fix the screen angle of the display so as not to be adjusted in response to a user operation on the angle adjuster.

According to another aspect of the present disclosure, a display module for a mobility device is provided. The display module comprises a display configured to display a gear area including a plurality of gear buttons in a first region, the first region being part of an entire display screen. The display module also comprises a controller configured to detect an change in an angle of the display, the change being caused by an external force applied to the display, and request output of a gear change control signal for changing to a gear corresponding to a changed angle.

In some embodiments, the controller is configured to be activated based on a predefined type of abnormality being detected in the display.

In some embodiments, the angle changed by the external force is an inclination angle corresponding to an upward/downward rotation relative to a horizontal axis.

In some embodiments, the gear area includes the plurality of gear buttons arranged vertically.

In some embodiments, the angle changed by the external force is an azimuth angle corresponding to a left/right rotation relative to a vertical axis.

In some embodiments, the gear area includes the plurality of gear buttons arranged horizontally.

According to still another aspect of the present disclosure, a gear shifting method is provided. The gear shifting method may be performed by a computing device. The gear shifting method includes displaying a gear area including a plurality of gear buttons in a first region, is the first region being part of an entire display screen of the computing device. The gear shifting method also includes outputting a gear change control signal in response to a user operation on the gear area. The gear shifting method additionally includes outputting an angle change signal for changing to an angle corresponding to a changed gear, and adjusting a screen angle of the computing device using the angle change signal.

In some embodiments, adjusting the screen angle includes tilting the computing device up and down with respect to a horizontal axis.

In some embodiments, adjusting the screen angle includes swiveling the computing device left and right with respect to a vertical axis.

According to still another aspect of the present disclosure, there a gear shifting method is provided. The gear shifting method may be performed by a computing device. The gear shifting method includes displaying a gear area including a plurality of gear buttons in a first region, which is part of an entire display screen of the computing device. The gear shifting method also includes detecting a change in an angle of the computing device, the change being caused by an external force applied to the computing device. The gear shifting method additionally includes outputting a gear change control signal for changing to a gear corresponding to a changed angle.

In some embodiments, outputting the gear change control signal includes outputting the gear change control signal based on detecting a predefined type of abnormality in the computing device.

In some embodiments, the angle changed by the external force is an inclination angle corresponding to an upward/downward rotation relative to a horizontal axis.

In some embodiments, the angle caused by the external force is an azimuth angle corresponding to a left/right rotation relative to a vertical axis.

It should be noted that the effects of the present disclosure are not limited to those described above. Other effects of the present disclosure should be more apparent to those having ordinary skill in the art from the following description.

### BRIEF DESCRIPTION OF THE DRAWINGS

FIG. 1 is a diagram for explaining an example in which a display module for a mobility device according to an embodiment of the present disclosure is used in a vehicle;

FIG. 2 is a configuration diagram of the display module for a mobility device according to an embodiment of the present disclosure;

FIGS. 3A-3D are diagrams for explaining examples in which a display of the display module is tilted in response to a user operation on a gear area in some embodiments of the present disclosure;

FIGS. 4A-4G are diagrams for explaining examples in which the display is swiveled in response to a user operation on the gear area in some embodiments of the present disclosure;

FIG. 5 is a flowchart of a gear shifting method according to an embodiment of the present disclosure;

FIG. 6 is a flowchart of a gear shifting method according to another embodiment of the present disclosure;

FIGS. 7A-7F are diagrams for explaining examples in which the angle of the display is changed in response to an external force applied by a user, resulting in a gear shift, in some embodiments of the present disclosure; and

FIG. 8 is a hardware configuration diagram of a computing device described in some embodiments of the present disclosure.

### DETAILED DESCRIPTION

Hereinafter, embodiments of the present disclosure are described in detail with reference to the accompanying drawings. Advantages and features of the present disclosure and methods of accomplishing the same should be more clearly understood from the following detailed description of embodiments and the accompanying drawings. The present disclosure may, however, be embodied in many different forms and should not be construed as being limited to the embodiments set forth herein. Rather, these embodiments are provided to make this disclosure thorough and complete and to fully convey the concept of the disclosure to those having ordinary skill in the art. The present disclosure is defined by the appended claims and equivalents thereof.

In adding reference numerals to the components of each drawing, it should be noted that the same reference numerals are assigned to the same components as much as possible even when the components are shown in different drawings. In addition, in the following description, where it was determined that a detailed description of the related well-known configuration or function would obscure the gist of the present disclosure, the detailed description thereof has been omitted.

Unless otherwise defined, all terms used in the present specification (including technical and scientific terms) are used in a sense that can be commonly understood by those having ordinary skill in the art. In addition, the terms defined in the commonly used dictionaries should not be ideally or excessively interpreted unless the terms are specifically defined clearly herein. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are merely for distinguishing the components from other components, and the nature or order of the components is not limited by the terms. If a component is described as being “connected,” “coupled” or “contacted” to another component, that component may be directly connected to or contacted with that other component, but it should be understood that one or more other components also may be “connected,” “coupled” or “contacted” between the two components.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

Hereinafter, embodiments of the present disclosure are described in detail with reference to the accompanying drawings.

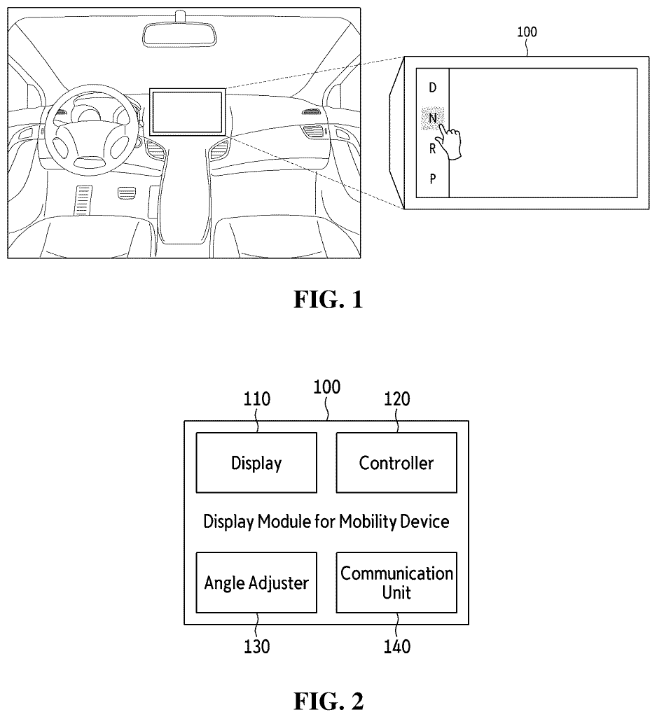

FIG. 1 is a diagram for explaining an example in which a display module (also sometimes referred to herein as “display device” or “display assembly”) for a mobility device according to an embodiment of the present disclosure is used in a vehicle. The display module for a mobility device according to an embodiment of the present disclosure may be installed in a vehicle to receive, from a driver, a request to change the gear of the vehicle. In the present disclosure, shifting the gear and changing the gear state of the vehicle may be considered equivalent.

FIG. 2 is a configuration diagram of the display module for a mobility device according to an embodiment of the present disclosure.

A display module (also sometimes referred to herein as “display device” or “display assembly”) 100 for a mobility device according to an embodiment of the present disclosure may include a display 110, a controller 120, an angle adjuster 130, and a communicator 140.

The display 110 may display a gear area that includes a plurality of gear buttons in a first region, which is part of the entire display screen of the display 110.

The plurality of gear buttons may include a drive (D) gear button, a neutral (N) gear button, a reverse (R) gear button, and a park (P) gear button. The D gear button may be a gear button associated with the D gear of the vehicle. The N gear button may be a gear button associated with the N gear of the vehicle. The R gear button may be a gear button associated with the R gear of the vehicle. The P gear button may be a gear button associated with the P gear of the vehicle. The plurality of gear buttons may be displayed in the gear area in the order of P, R, N, and D. This order may prevent unintended movement of the vehicle in a direction opposite to the driver's intention by spacing the positions of the D gear button and the R gear button apart from each other.

The gear area may be an area in which the plurality of gear buttons are arranged side by side. Since the plurality of gear buttons are arranged side by side in the gear area, the driver may intuitively recognize and select the gear buttons.

When a gear change occurs in response to a user operation on the gear area, the controller 120 may output an angle adjustment signal for changing to an angle corresponding to the gear change. For example, the controller 120 may function as a transmission control unit (TCU) that activates a solenoid valve to change hydraulic pressure and shift gears.

The user operation may include a selection by a user of one of the gear buttons included in the gear area. For example, the user's selection may include a touch operation by the user on one of the gear buttons included in the gear area through the display 110.

The gear change control signal may include a control signal that requests a change to the gear corresponding to the user operation on the gear area.

The angle corresponding to the gear change may refer to an angle corresponding to the gear button selected by the user operation, among a plurality of predefined angles assigned to the plurality of gear buttons included in the gear area.

The angle adjustment signal may include a signal that requests a change in the screen angle of the display 110 to the angle corresponding to the gear change. The screen angle may refer to a tilt or rotational angle of the display 110 included in the display module 100. In particular, the screen angle may refer to a tilt of the display 110 adjusted based on the user's line of sight.

The angle adjuster 130 may adjust the screen angle of the display 110 by receiving the angle adjustment signal from the controller 120. By adjusting the screen angle of the display 110 based on the angle adjustment signal from the controller 120, the user may intuitively recognize the changed gear state of the vehicle. For example, the angle adjuster 130 (e.g., a display adjustment assembly or mechanism) may comprise one or more of an actuator, a hinge, a swivel joint, an adjustable bracket, etc., for adjusting the screen angle of the display 110. In other embodiments, the angle adjuster 130 may additionally or alternatively include other suitable adjustment mechanisms for adjusting the screen angle of the display 110.

In addition, the angle adjuster 130 may fix the display 110 so that the screen angle of the display 110 is not adjusted in response to the user operation. For example, the user may fix the display 110 so that its screen angle is not adjustable, as needed.

The communicator 140 may enable smooth data exchange between the TCU and the vehicle's gear shifting device of the vehicle, thereby ensuring accurate and efficient gear shifting of the vehicle. For example, data may be exchanged in real time between the TCU and the gear shifting device using a communication protocol such as a Controller Area Network (CAN) bus.

By shifting gears through the display 110, physical levers or knobs can be eliminated, securing space inside the vehicle. In addition, the gear shifting device based on the display 110 can be easily linked with other electronic devices in the vehicle, enabling additional functions such as navigation or vehicle diagnostics to be used together.

The display module according to an embodiment of the present disclosure may be more fully understood by referring to other embodiments to be described later. In addition, the technical concepts derived from the foregoing embodiments may be reflected in other embodiments to be described later, even if not explicitly stated.

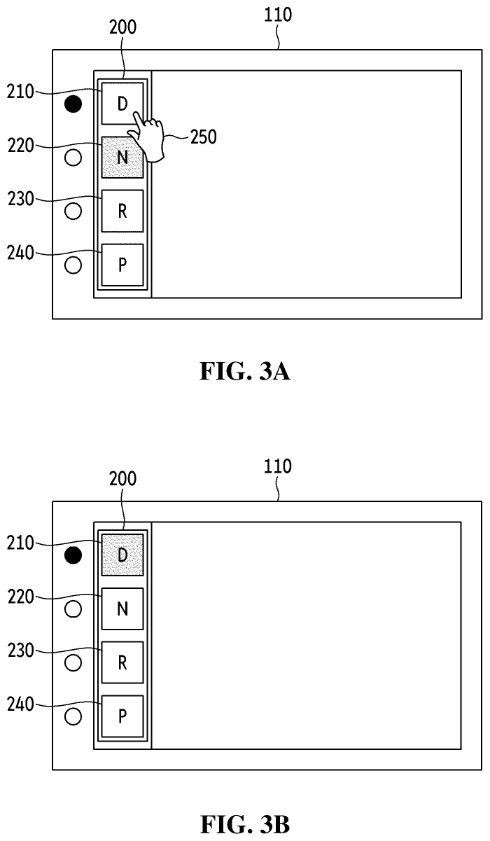

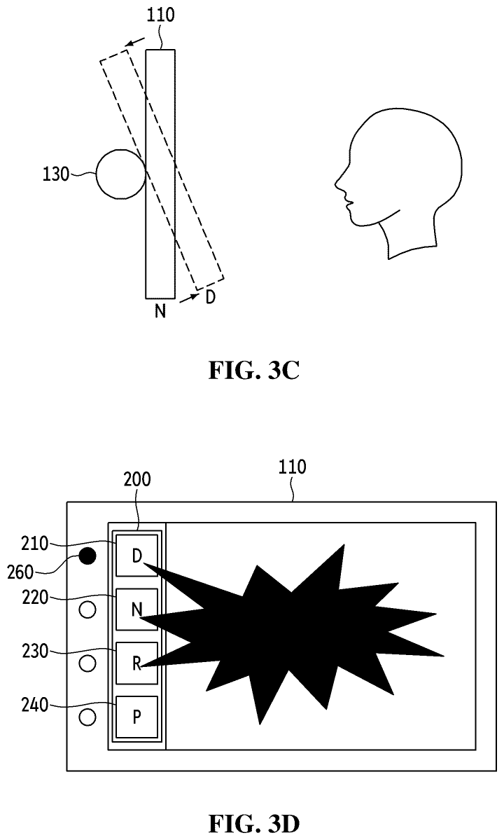

FIGS. 3A-3D are diagrams for explaining examples in which the display is tilted in response to a user operation on the gear area in some embodiments of the present disclosure. In an embodiment, tilting may refer to the display rotating up and down with respect to a horizontal axis.

In some embodiments, as illustrated in FIG. 3A, a user operation 250 on a gear area 200 may be received. The gear area 200 may include a plurality of gear buttons 210, 220, 230, and 240 in a first region, which is part of the entire display screen of the display 110. The plurality of gear buttons 210, 220, 230, and 240 may include a D gear button 210, an N gear button 220, an R gear button 230, and a P gear button 240. The first region may be a partial region of the entire display screen of the display 110 that is horizontal or vertical depending on the rotational angle of the display 110. For example, when the display 110 is tilted up and down with respect to the horizontal axis, the first region may be arranged vertically. In addition, when the display 110 is swiveled left and right with respect to a vertical axis, the first region may be arranged horizontally. By changing the display orientation of the first region according to the rotational angle of the display 110, the driver may intuitively confirm the current gear state, enhancing convenience during gear shifting.

In some embodiments, as illustrated in FIG. 3B, in response to the user operation 250 on the gear change area 200, the display 110 may display the gear button corresponding to a gear change in a visually different manner from the other gear buttons. For example, the gear button corresponding to the gear change may be shaded to be visually distinguishable from the rest of the plurality of gear buttons 210, 220, 230, and 240. In an embodiment, the rest of the plurality of gear buttons 210, 220, 230, and 240 may refer to the plurality of gear buttons 210, 220, 230, and 240, excluding the D gear button 210 corresponding to the gear change, i.e., the N, R, and P gear buttons 220, 230, and 240.

In some embodiments, as illustrated in FIG. 3C, the angle adjuster 130 may tilt the display 110 up and down with respect to the horizontal axis. The angle adjuster 130 may tilt the display 110 to a predefined angle corresponding to the changed gear, with respect to the horizontal axis. For example, when the changed gear is the D gear, the angle adjuster 130 may tilt the display 110 by 10 degrees with respect to the horizontal axis. The screen angle of the display 110 may be adjusted by the angle adjuster 130 so that the user may intuitively recognize the changed gear state of the vehicle. In addition, the gear area 200 may include the plurality of gear buttons 210, 220, 230, and 240 arranged vertically. Referring to FIG. 3A, the plurality of gear buttons 210, 220, 230, and 240 may be arranged vertically in the gear area 200. The plurality of gear buttons 210, 220, 230, and 240 may be arranged vertically in the order of P-R-N-D.

As illustrated in FIG. 3D, the display module according to an embodiment of the present disclosure may include lamps 260 that display the current gear state of the vehicle, near the first region, when a predefined type of abnormality occurs in the display 110. For example, when the current gear of the vehicle is the D gear, but a predefined type of abnormality occurs in the display 110 so that gear shifting through the display 110 is not possible, the lamp 260 adjacent to the D gear button 210 may be activated to indicate the current gear state of the vehicle. In addition, the other lamps 260 may be deactivated so that the driver can identify the current gear state. In some embodiments, the position of the lamps 260 may vary depending on the arrangement of the plurality of gear buttons 210, 220, 230, and 240.

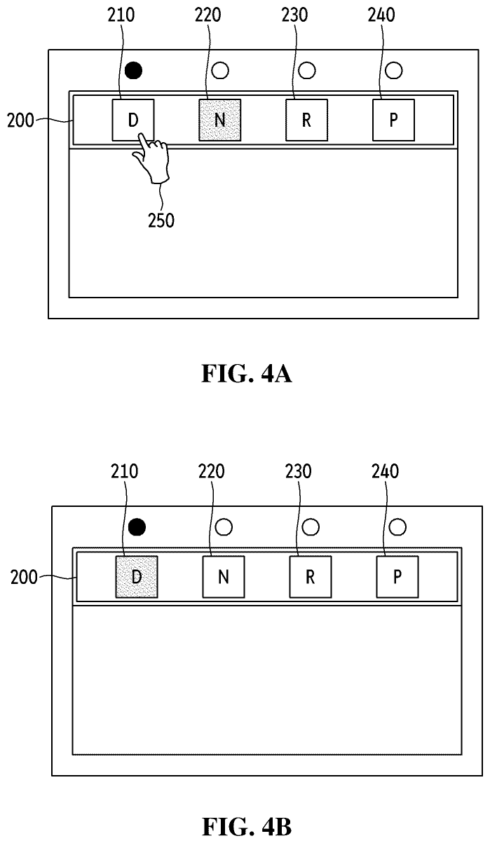

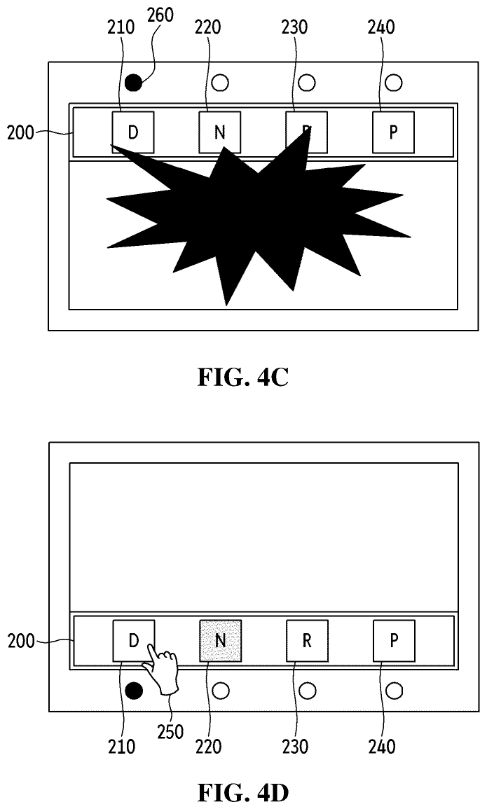

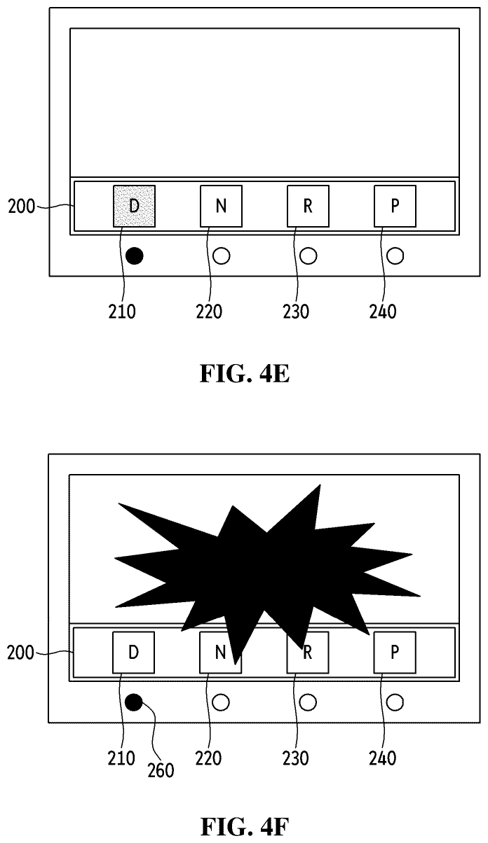

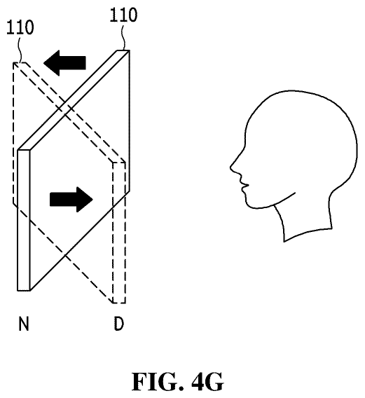

For example, when the plurality of gear buttons 210, 220, 230, and 240 are arranged vertically, the lamps 260 may be located to the left of the respective gear buttons 210, 220, 230, and 240. In addition, when the plurality of gear buttons 210, 220, 230, and 240 are arranged horizontally and placed at the top of the display 110, the lamps 260 may be located above the respective gear buttons 210, 220, 230, and 240 (see FIG. 4C). Furthermore, when the plurality of gear buttons 210, 220, 230, and 240 are arranged horizontally and placed at the bottom of the display 110, the lamps 260 may be located below the respective gear buttons 210, 220, 230, and 240 (see FIG. 4F). Accordingly, by adjusting the position of the lamps 260 according to the rotation direction of the display 110, the driver may intuitively recognize the current gear state of the vehicle even if an abnormality is detected in the display 110.

FIGS. 4A-4G are diagrams for explaining examples in which the display is swiveled in response to a user operation on the gear area in some embodiments of the present disclosure. Here, swiveling may refer to the display 110 rotating left and right with respect to the vertical axis.

In some embodiments, as illustrated in FIGS. 4A-4G , the angle adjuster 130 may swivel the display 110 left and right with respect to the vertical axis. The angle adjuster 130 may swivel the display 110 to a predefined angle corresponding to a changed gear, left and right with respect to the vertical axis. For example, when the changed gear is the D gear, the angle adjuster 130 may swivel the display 110 by 10 degrees with respect to the vertical axis. The screen angle of the display 110 may be adjusted by the angle adjuster 130 so that the user may intuitively recognize the changed gear state of the vehicle. In addition, the gear area 200 may include a plurality of gear buttons 210, 220, 230, and 240 arranged horizontally. Referring to FIG. 4A, the plurality of gear buttons 210, 220, 230, and 240 may be arranged horizontally in the gear area 200. The plurality of gear buttons 210, 220, 230, and 240 may be arranged horizontally in the order of D-N-R-P. The plurality of gear buttons 210, 220, 230, and 240 may be positioned at the top of the display 110.

In some embodiments, as illustrated in FIG. 4A, the N gear button 220 may be displayed to be visually distinguishable from the other gear buttons 210, 230, and 240. That is, the current gear state of the vehicle may be the N gear state. In an embodiment, in response to a user operation on the gear area 200, the gear button corresponding to the changed gear may be displayed to be visually distinguishable from the rest of the plurality of gear buttons 210, 220, 230, and 240.

As an example, referring to FIG. 4B, in response to another user operation after displaying the N gear button 220 to be visually distinguishable from the other gear buttons 210, 230, and 240, as illustrated in FIG. 4A, the D gear button 210 may be shaded and emphasized accordingly. Then, the user may immediately recognize the changed current gear state.

In some embodiments, as illustrated in FIGS. 4D-4E , the plurality of gear buttons 210, 220, 230, and 240 may be positioned at the bottom of the display 110.

FIG. 4G is a diagram for explaining an example in which the display of the display module according to an embodiment of the present disclosure is swiveled. For example, when the current gear state is the N gear state and the user inputs an operation for the D gear button, the display 110 may be swiveled from the screen angle for the N gear button to the screen angle for the D gear button in response to the user operation.

A display module according to another embodiment of the present disclosure may include a display and a controller.

The display may display a gear area including a plurality of gear buttons in a first region, which is part of the entire display screen of the display.

The controller may detect an angle change caused by an external force applied to the display and may request output of a gear change control signal for changing to a gear corresponding to the changed angle. The external force applied to the display may be a force exerted by a user. For example, the user may apply an external force to change the screen angle of the display installed in the vehicle while driving. The gear corresponding to the changed angle may refer to a gear associated with a specific screen angle of the display.

In some embodiments, the controller may be activated only when a predefined type of abnormality is detected in the display. Activation may refer to the controller detecting an angle change caused by an external force applied to the display and requesting an electronic control device to output a gear change control signal for changing to a gear corresponding to the changed angle. The predefined type of abnormality may include a failure in which the display cannot detect a user operation on the gear area. As another example, the predefined type of abnormality may include a failure in the software governing the gear area. When a failure occurs in the software governing the gear area, the user may manually adjust the angle of the display to change the gear state. In addition to the predefined type of abnormality, the control logic of the controller may also include various types of abnormalities in which the screen angle of the display is not normally adjusted, such as when a gear change occurs in response to a user operation on the gear area and the controller outputs an angle adjustment signal for changing to an angle corresponding to the changed gear.

By activating the controller only when the predefined type of abnormality is detected in the display, the user may still manually adjust the screen angle of the display to change the gear even when the display does not operate normally. Accordingly, even in emergency situations where the display does not function properly, the user may safely drive the vehicle.

In some embodiments, the angle corresponding to the external force may be an inclination angle, which is a rotation up and down with respect to the horizontal axis. That is, the user may shift the gear by tilting the display. When the display is tilted, the vehicle may be shifted to a gear corresponding to the changed screen angle of the display, and the gear area displayed on the display may be updated. For example, when the current gear state of the vehicle is set to the P gear and the user tilts the display to the screen angle corresponding to the D gear, the vehicle may be shifted to the D gear, and the D gear button among the plurality of gear buttons included in the gear area displayed on the display may be emphasized in a visually distinguishable manner from the N, R, and P gear buttons. This type of display method may include shading the surroundings of the D gear button.

In some embodiments, the gear area may include the plurality of gear buttons arranged vertically. By arranging the plurality of gear buttons vertically, the gear button corresponding to the current gear of the vehicle among the vertically arranged gear buttons may also be visualized when the screen angle of the display is rotated up and down, allowing the user to intuitively confirm the current gear of the vehicle.

In some embodiments, the angle corresponding to the external force may be an azimuth angle, which is a rotation left and right with respect to a vertical axis. That is, the user may shift the gear by swiveling the display. When the display is swiveled, the vehicle may be shifted to a gear corresponding to the changed screen angle of the display, and the gear area displayed on the display may be updated. For example, when the current gear state of the vehicle is set to the P gear and the user swivels the display to the screen angle corresponding to the D gear, the vehicle may be shifted to the D gear, and the D gear button among the plurality of gear buttons included in the gear area displayed on the display may be emphasized in a visually distinguishable manner from the N, R, and P gear buttons. This type of display method may include shading the surroundings of the D gear button.

In some embodiments, the gear area may include the plurality of gear buttons arranged horizontally. By arranging the plurality of gear buttons horizontally, the gear button corresponding to the current gear of the vehicle among the horizontally arranged gear buttons may also be visualized when the screen angle of the display is rotated left and right, allowing the user to intuitively confirm the current gear of the vehicle.

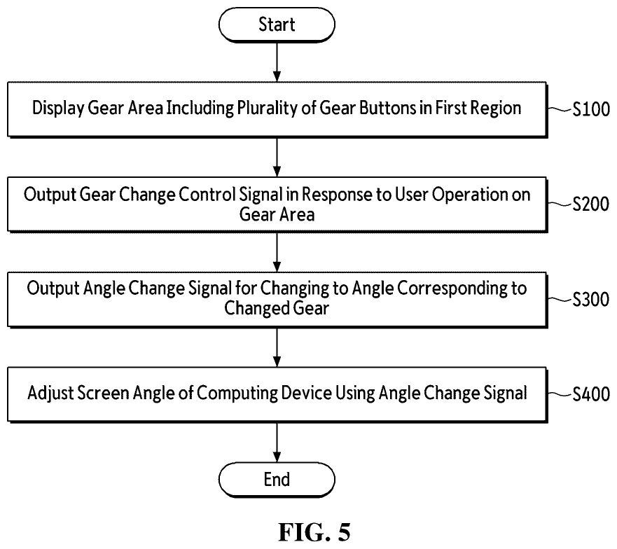

FIGS. 5 and 6 are flowcharts of gear shifting methods according to embodiments of the present disclosure. The gear shifting methods of FIGS. 5 and 6 may be performed by one or more computing devices. In addition, in the gear shifting methods of FIGS. 5 and 6, some operations or steps may be performed by a first computing device, and the remaining operations or steps may be performed by a second computing device. For example, some operations or steps of the gear shifting methods of FIGS. 5 and 6 may be performed by a service server, and the remaining operations or steps of the gear shifting methods of FIGS. 5 and 6 may be performed by a user terminal.

When the subject performing each operation or step is omitted, it may be understood that the subject is a computing device. In addition, it is noted that the embodiments related to the display module described with reference to FIG. 1 may also be applied to the gear shifting methods of FIGS. 5 and 6, unless otherwise specified.

As illustrated in FIG. 5, a gear shifting method according to an embodiment of the present disclosure may include: an operation S100 of displaying a gear area including a plurality of gear buttons in a first region, which is part of the entire display screen of a computing device; an operation S200 of outputting a gear change control signal in response to a user operation on the gear area; an operation S300 of outputting an angle adjustment signal for changing to an angle corresponding to the changed gear; and an operation S400 of adjusting the screen angle of the computing device using the angle adjustment signal.

In the operation S100, the gear button corresponding to the current gear state of the vehicle among the plurality of gear buttons included in the gear area may be displayed in a visually distinguishable manner from the rest of the plurality of gear buttons. In some embodiments, the gear area may include a plurality of gear buttons arranged vertically. In some embodiments, the gear area may include a plurality of gear buttons arranged horizontally.

In the operation S400, the screen angle of the computing device may be adjusted up and down with respect to a horizontal axis. In some embodiments, the screen angle of the computing device may be adjusted left and right with respect to a vertical axis.

As illustrated in FIG. 6, a gear shifting method according to another embodiment of the present disclosure may include: an operation S700 of displaying a gear area including a plurality of gear buttons in a first region, which is part of the entire display screen of a computing device; an operation S800 of detecting an angle change caused by an external force applied to the computing device; and an operation S900 of outputting a gear change control signal for changing to a gear corresponding to the changed angle.

In the operation S800, the angle corresponding to the external force may be an inclination angle, which is an upward/downward rotation relative to a horizontal axis.

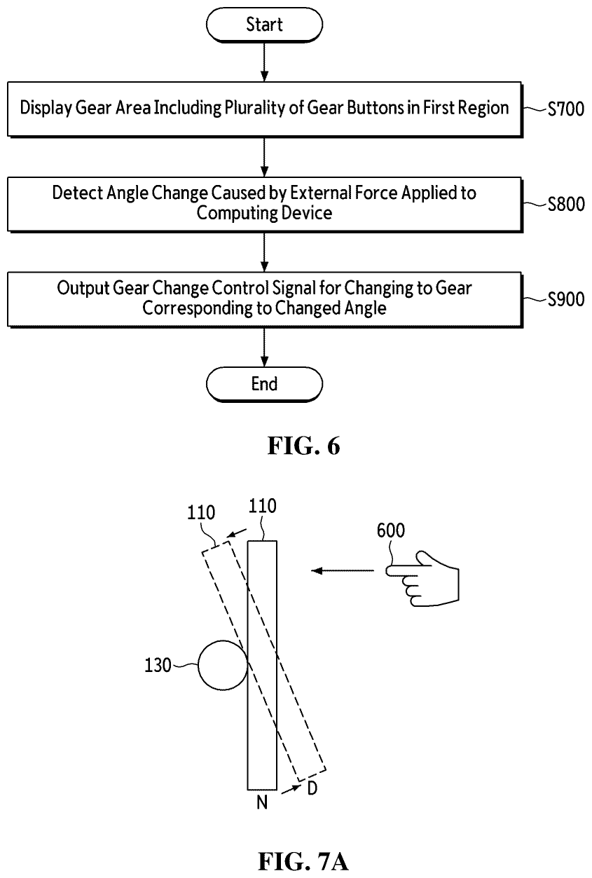

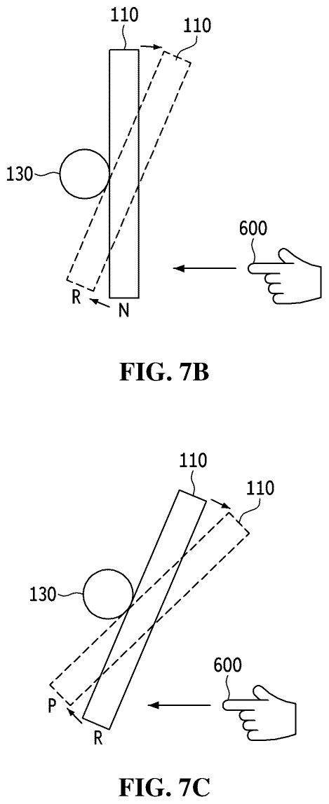

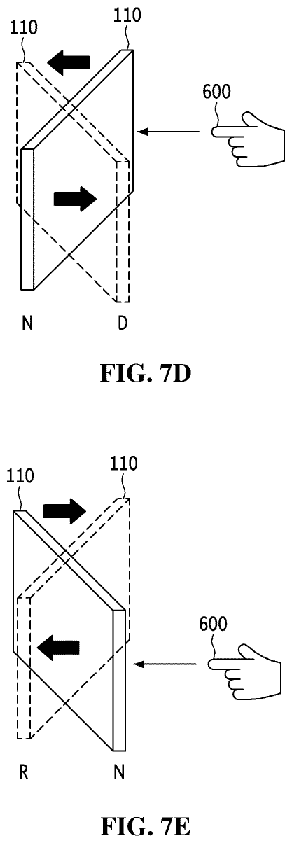

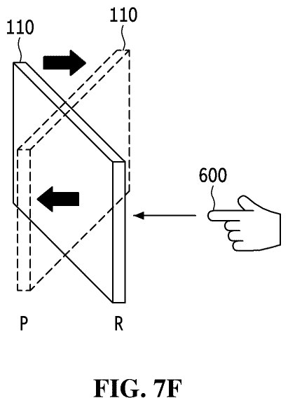

In some embodiments, as illustrated in FIG. 7A, from the N gear state, when the user applies an external force 600 to the upper portion of the display 110, the screen angle of the display 110 may be adjusted, and the vehicle may be shifted to the D gear state. At this time, the user may feel resistance from the angle adjuster 130 while applying the external force 600. In addition, after the vehicle is shifted to the D gear state, even if the user applies the external force 600 to the upper portion of the display 110, the angle of display 110 may not be adjusted.

In other embodiments, as illustrated in FIG. 7B, from the N gear state, when the user applies an external force 600 to the lower portion of the display 110, the screen angle of the display 110 may be adjusted, and the vehicle may be shifted to the R gear state. At this time, the user may feel resistance from the angle adjuster 130 while applying the external force 600.

In still other embodiments, as illustrated in FIG. 7C, from the R gear state, when the user applies an external force 600 to the lower portion of the display 110, the screen angle of the display 110 may be adjusted, and the vehicle may be shifted to the P gear state. At this time, the user may feel resistance from the angle adjuster 130 while applying the external force 600. In addition, in the P gear state, even if the user applies the external force 600 to the lower portion of the display 110, the angle of the display 110 may not be adjusted.

Alternatively, in the operation S800, the angle corresponding to the external force may be an azimuth angle, which is a left/right rotation relative to a vertical axis.

In some embodiments, as illustrated in FIG. 7D, from the N gear state, when the user applies an external force 600 to the right portion of the display 110, the screen angle of the display 110 may be adjusted, and the vehicle may be shifted to the D gear state. At this time, the user may feel resistance from the angle adjuster 130 while applying the external force 600. In addition, after the vehicle is shifted to the D gear state, even if the user applies the external force 600 to the right portion of the display 110, the angle of the display 110 may not be adjusted.

In other embodiments, as illustrated in FIG. 7E, from the N gear state, when the user applies an external force 600 to the left portion of the display 110, the screen angle of the display 110 may be adjusted, and the vehicle may be shifted to the R gear state. At this time, the user may feel resistance from the angle adjuster 130 while applying the external force 600.

In still other embodiments, as illustrated in FIG. 7F, from the R gear state, when the user applies an external force 600 to the left portion of the display 110, the screen angle of the display 110 may be adjusted, and the vehicle may be shifted to the P gear state. At this time, the user may feel resistance from the angle adjuster 130 while applying the external force 600. In addition, in the P gear state, even if the user applies the external force 600 to the left portion of the display 110, the angle of the display 110 may not be adjusted.

In the operation S900, outputting the gear change control signal may include outputting the gear change control signal only when a predefined type of abnormality is detected in the display.

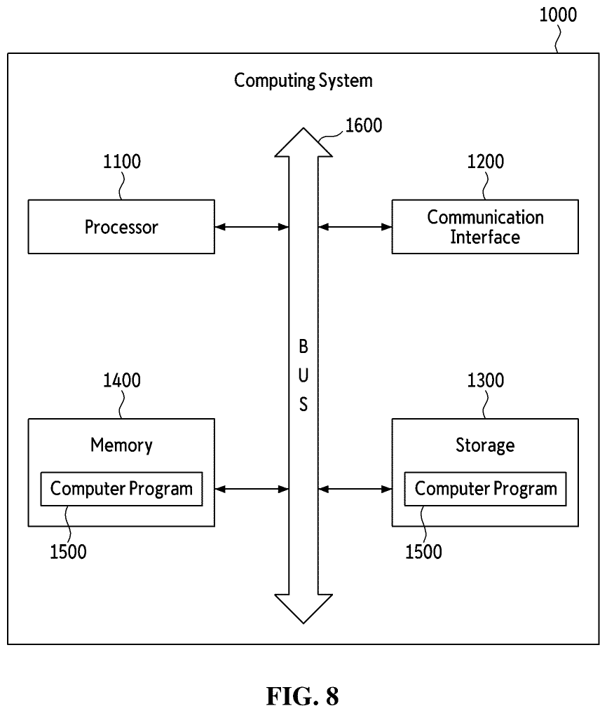

FIG. 8 is a hardware configuration diagram of a computing system described in some embodiments of the present disclosure. Referring to FIG. 8, a computing device 1000 may include at least one processor 1100, a bus 1600, a communication interface 1200, a memory 1400 that loads a computer program 1500 executed by the processor 1100, and a storage 1300 that stores the computer program 1500. However, only components relevant to the embodiments of the present disclosure are illustrated in FIG. 8. Therefore, one of ordinary skill in the art to which the present disclosure pertains should recognize that, in addition to the components depicted in FIG. 8, other general-purpose components may be further included. Accordingly, the computing device 1000 may further include various components in addition to those illustrated in FIG. 8. In some embodiments, the computing device 1000 may be configured without some of the components illustrated in FIG. 8. Each component of the computing device 1000 is hereinafter described in more detail. Throughout the present disclosure, the terms “computing device” and “computing system” may be used interchangeably.

The processor 1100 may control overall operations of the components of the computing device 1000. The processor 1100 may include at least one of a central processing unit (CPU), a micro processing unit (MPU), a micro controller unit (MCU), a graphics processing unit (GPU), or any other type of processor well known in the technical field of the present disclosure. The processor 1100 may perform computations for executing at least one application or program to implement operations or methods according to various embodiments of the present disclosure. The computing device 1000 may include one or more processors 1100.

The memory 1400 may store various types of data, commands, and/or information. The memory 1400 may load the computer program 1500 from the storage 1300 to execute the operations or methods according to various embodiments of the present disclosure. The memory 1400 may be implemented as volatile memory such as random-access memory (RAM), but the present disclosure is not limited thereto.

The bus 1600 may provide communication functions between the components of the computing device 1000. The bus 1600 may be implemented as various types of buses, including an address bus, a data bus, and a control bus.

The communication interface 1200 may support wired or wireless Internet communication of the computing device 1000. In addition to Internet communication, the communication interface 1200 may support various other types of communication. To this end, the communication interface 1200 may include a communication module well known in the technical field of the present disclosure.

The storage 1300 may non-transitorily store one or more computer programs 1500 (e.g., in the form of computer-readable instructions). The storage 1300 may include a nonvolatile memory such as read-only memory (ROM), erasable programmable ROM (EPROM), electrically erasable programmable ROM (EEPROM), or flash memory, a hard disk, a removable disk, or any other computer-readable recording medium known in the technical field of the present disclosure.

The computer program 1500 may include one or more computer-readable instructions that, when loaded into the memory 1400, cause the processor 1100 to perform the operations or methods according to various embodiments of the present disclosure. The processor 1100 may execute the loaded instructions to perform the operations or methods according to various embodiments of the present disclosure.

For example, the computing device 1000 of FIG. 8 may be the computing device included in the display module described with reference to FIG. 1. The computing device 1000 may be implemented using one or more physical servers included in a server farm based on cloud technology such as virtual machines. In this case, at least some of the components illustrated in FIG. 8, including the processor 1100, the memory 1400, and the storage 1300, may be virtual hardware, and the communication interface 1200 may be implemented as a virtualized networking element, such as a virtual switch. The various embodiments and effects of the present disclosure have thus far been described with reference to FIGS. 1-8 . The effects of the technical idea of the present disclosure are not limited to those described above and may be clearly understood by those having ordinary skill in the art from the following description.

The computer program 1500 may include computer-readable instructions for displaying a gear area including a plurality of gear buttons in a first region, which is part of the entire display screen of the computing device 1000, and computer-readable instructions for detecting a change in an angle caused by an external force applied to the computing device 1000 and outputting a gear change control signal for changing to a gear corresponding to the changed angle.

Various embodiments of the present disclosure and the effects according to embodiments thereof have been described in detail with reference to FIGS. 1-8 . The effects according to the technical idea of the present disclosure are not limited to the forementioned effects. Other effects not mentioned herein should be more clearly understood by those having ordinary skill in the art from the description of the specification.

The technical features of the present disclosure may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

Although the present disclosure has been described above with reference to several embodiments, those having ordinary skill in the art should appreciate that variations and modifications may be made to the described embodiments without departing from the principles of the present disclosure. Therefore, the described embodiments of the present disclosure are provided in a generic and descriptive sense only and not for purposes of limitation.

What is claimed is:

1. A display module for a mobility device, the display module comprising:
a display configured to display a gear area including a plurality of gear buttons in a first region, the first region being part of an entire display screen;
a controller configured to output an angle change signal for changing to an angle corresponding to a changed gear, based on determining occurrence of a gear change in response to a user operation on the gear area; and
an angle adjuster configured to receive the angle change signal from the controller and adjust a screen angle of the display.

2. The display module of claim 1, wherein the display is configured to display a gear button, among the plurality of gear buttons, corresponding to the changed gear in a visually different manner from other gear buttons among the plurality of gear buttons.

3. The display module of claim 1, wherein the angle adjuster is configured to tilt the display up and down with respect to a horizontal axis.

4. The display module of claim 3, wherein the gear area includes the plurality of gear buttons arranged vertically.

5. The display module of claim 1, wherein the angle adjuster is configured to swivel the display left and right with respect to a vertical axis.

6. The display module of claim 5, wherein the gear area includes the plurality of gear buttons arranged horizontally.

7. The display module of claim 1, wherein the angle adjuster is configured to fix the screen angle of the display so as not to be adjusted in response to a user operation on the angle adjuster.

8. A display module for a mobility device, comprising:
a display configured to display a gear area including a plurality of gear buttons in a first region, the first region being part of an entire display screen; and
a controller configured to:
detect a change in an angle of the display, the change being caused by an external force applied to the display, and
request output of a gear change control signal for changing to a gear corresponding to a changed angle.

9. The display module of claim 8, wherein the controller is activated based on a predefined type of abnormality being detected in the display.

10. The display module of claim 8, wherein the angle changed by the external force is an inclination angle corresponding to an upward/downward rotation relative to a horizontal axis.

11. The display module of claim 10, wherein the gear area includes the plurality of gear buttons arranged vertically.

12. The display module of claim 8, wherein the angle changed by the external force is an azimuth angle corresponding to a left/right rotation relative to a vertical axis.

13. The display module of claim 12, wherein the gear area includes the plurality of gear buttons arranged horizontally.

14. A gear shifting method performed by a computing device, the gear shifting method comprising:
displaying a gear area including a plurality of gear buttons in a first region, the first region being part of an entire display screen of the computing device;
outputting a gear change control signal in response to a user operation on the gear area;
outputting an angle change signal for changing to an angle corresponding to a changed gear; and
adjusting a screen angle of the computing device using the angle change signal.

15. The gear shifting method of claim 14, wherein adjusting of screen angle includes tilting the computing device up and down with respect to a horizontal axis.

16. The gear shifting method of claim 14, wherein adjusting the screen angle includes swiveling the computing device left and right with respect to a vertical axis.

17. A gear shifting method performed by a computing device, comprising:
displaying a gear area including a plurality of gear buttons in a first region, the first region being part of an entire display screen of the computing device;
detecting a change in an angle of the computing device, the change being caused by an external force applied to the computing device; and
outputting a gear change control signal for changing to a gear corresponding to a changed angle.

18. The gear shifting method of claim 17, wherein outputting the gear change control signal includes outputting the gear change control signal based on detecting a predefined type of abnormality in the computing device.

19. The gear shifting method of claim 17, wherein the angle changed by the external force is an inclination angle corresponding to an upward/downward rotation relative to a horizontal axis.

20. The gear shifting method of claim 17, wherein the angle caused by the external force is an azimuth angle corresponding to a left/right rotation relative to a vertical axis.
